(19) United States
(12) Patent Application Publication
(10) Pub. No.: US 2026/0138911 A1
(43) Pub. Date: May 21, 2026

(54) GLASS SHEET, METHOD OF MANUFACTURING GLASS SHEET, METHOD OF MANUFACTURING GLASS SHEET WITH RESIN FILM, METHOD OF MANUFACTURING RESIN FILM, AND MANUFACTURING APPARATUS FOR GLASS SHEET

(71) Applicant: NIPPON ELECTRIC GLASS CO., LTD., Shiga (JP)

(72) Inventors: Hiroshi SAWASATO, Shiga (JP); Shusaku TAMAMURA, Shiga (JP); Masahide YASUHARA, Shiga (JP); Shinji OHIGASHI, Shiga (JP)

(21) Appl. No.: 19/120,993

(22) PCT Filed: Nov. 22, 2023
(86) PCT No.: PCT/JP2023/042021

§ 371 Date: Apr. 14, 2025

(30) Foreign Application Priority Data
Dec. 1, 2022 (JP) 2022-192951

(51) Int. Cl. C03B 25/12; C03B 13/04; C03B 13/16; C03B 33/02; C03B 35/16

(52) U.S. Cl. CPC C03B 25/12; C03B 13/04; C03B 13/16; C03B 33/0215; C03B 35/16

(57) ABSTRACT

A glass sheet (1) having a rectangular shape includes a first side (1y) along a sheet-drawing direction (Y) and a second side (1x) along a width direction (X), and has a length of each of the first side (1y) and the second side (1x) of 1,000 mm or more, and a sheet thickness of 0.1 mm or more and 2.0 mm or less. When five evaluation regions (A) to (E) having rectangular shapes of the same size are sequentially set from one end side in the width direction (X), the absolute value of the average of the front-back deflection differences (X1−X2) of the evaluation regions (A) to (E) in the width direction (X) is 0.06 mm or more and 0.8 mm or less.

### TECHNICAL FIELD

The present invention relates to a glass sheet having a curved shape and a manufacturing technology for the sheet.

### BACKGROUND ART

In a manufacturing process for an electronic device such as a panel display (e.g., a liquid crystal display, an OLED display, or a plastic OLED display), a film-forming step of forming a film on a glass sheet (mother glass) is performed.

As an example of the film-forming step, in Patent Literature 1, there is a disclosure of the following approach: a thin-film device is manufactured by forming a metal film on the convex surface of a glass sheet having a dome-type or bowl-type curved shape through film formation treatment involving heating; and the thin-film device is subjected to cooling (including natural cooling) to about room temperature.

According to the approach, in the course of the cooling of the thin-film device having formed thereon the metal film, a tensile stress acts on the metal film because the thermal expansion coefficient of the metal film is larger than that of the glass sheet. Accordingly, it can be expected that the shapes of the glass sheet, and by extension, the thin-film device can be flattened.

In addition, in the literature, as a method of manufacturing a glass sheet having a curved shape, there is a disclosure that a thermal profile or a thermal history at the time of the forming of a glass ribbon by an overflow down-draw method or the like is adjusted.

Further, in the literature, there is a disclosure that to know the shape of a glass sheet cut out of the above-mentioned glass ribbon, the shape of the glass sheet in a gravity-free state is measured.

Meanwhile, in Patent Literature 2, there is a disclosure that a concept called a front-back deflection difference is introduced into the evaluation of the curved shape of a glass sheet.

More specifically, in the literature, there is a disclosure of the following: a plurality of evaluation regions are set in the glass sheet; a front-back deflection difference is determined from the measurement of the deflections of sample glasses corresponding to these regions; and the curved shape of the glass sheet is evaluated on the basis of the front-back deflection difference.

### CITATION LIST

Patent Literature 1: JP 2018-506497 A
Patent Literature 2: WO 2022/097537 A1

### SUMMARY OF INVENTION

### Technical Problem

Incidentally, in Patent Literature 1, as a manufacturing apparatus for a glass sheet having a curved shape, there is only a disclosure of an apparatus having a general configuration, the apparatus being configured to manufacture a glass sheet by an overflow down-draw method (see FIG. 13 of the literature). Accordingly, it is difficult to obtain a glass sheet having a curved shape suitable for being subjected to film formation treatment involving heating merely through the adjustment of a thermal profile or a thermal history at the time of the forming of a glass ribbon as described above.

The term “film formation treatment involving heating” as used herein refers to, for example, treatment comprising: applying a film material to the main surface of a glass sheet; and then sintering the resultant to cure the film material. In the following description, the “film formation treatment involving heating” is simply referred to as “heating film formation treatment.”

In addition, when the shape of a glass sheet is measured under a gravity-free state as disclosed in Patent Literature 1, a large measurement error may occur, and the measurement and posttreatment take time. Accordingly, it is difficult to accurately and quickly measure the shape of the glass sheet, and to obtain a glass sheet having a curved shape suitable for being subjected to heating film formation treatment.

Further, a sheet-drawing direction and a width direction perpendicular thereto are present in a glass sheet formed by a down-draw method or a float method. In Patent Literature 1, however, at the time of the measurement and evaluation of a glass sheet, its sheet-drawing direction and width direction are not distinguished from each other. Accordingly, the measurement and the evaluation become insufficient to obtain a glass sheet having a curved shape suitable for being subjected to heating film formation treatment.

Meanwhile, in Patent Literature 2, measurement and an evaluation are performed while a sheet-drawing direction and a width direction are distinguished from each other. In a technical proposal disclosed in the literature, however, an adsorption surface plate is caused to suitably adsorb the convex surface of a glass sheet having a curved shape. Accordingly, even when the technical proposal disclosed in the literature is applied to a technical proposal in which a glass sheet having a curved shape is subjected to heating film formation treatment, an appropriate configuration, and an appropriate action and effect cannot be obtained.

In addition, the inventors of the present invention have been performing the following research: a resin film is formed on the convex surface of a glass sheet having a curved shape by heating film formation treatment, and is cooled to flatten the glass sheet; and then the resin film is peeled from the glass sheet, and the film is used in the manufacture of an electronic device. In the research, unless the shape of the glass sheet is flattened at the time point when the sheet is cooled to about room temperature, the operation of peeling the resin film from the glass sheet becomes difficult. Accordingly, even in this case, it is important to obtain a glass sheet having a curved shape suitable for being subjected to heating film formation treatment.

From the foregoing viewpoints, an object of the present invention is to provide a glass sheet having a curved shape suitable for being subjected to heating film formation treatment and a manufacturing technology for the sheet.

### Solution to Problem

(a) According to a first aspect of the present invention, which has been devised to achieve the above-mentioned object, there is provided a glass sheet having a rectangular shape, comprising: a first main surface; a second main surface on a back side of the first main surface; a first side along a sheet-drawing direction; and a second side along a width direction perpendicular to the sheet-drawing direction, the glass sheet having a length of each of the first side and the second side of 1,000 mm or more, and a sheet thickness of 0.1 mm or more and 2.0 mm or less, wherein when five evaluation regions having rectangular shapes of the same size are sequentially set from one end side in the width direction, an absolute value of an average of front-back deflection differences of the five evaluation regions in the width direction determined by the following equation (1) is 0.06 mm or more and 0.8 mm or less:

front-back deflection difference=(X1−X2) (1)
where X1 represents a deflection [mm] of a sample glass, which corresponds to the evaluation region whose front-back deflection difference is measured, in the width direction when the first main surface is directed downward, and X2 represents a deflection [mm] of the sample glass, which corresponds to the evaluation region whose front-back deflection difference is measured, in the width direction when the second main surface is directed downward.

With such configuration, the glass sheet has such a curved shape that one main surface out of the first main surface and the second main surface becomes a convex surface in the width direction. Moreover, the curving degree of the glass sheet in the width direction is large because the absolute value of the average of the above-mentioned front-back deflection differences is 0.06 mm or more and 0.8 mm or less. Accordingly, in the case where the convex surface of the glass sheet is subjected to heating film formation treatment, even when the thermal expansion coefficient of the resultant film is considerably larger than that of the glass sheet, the shape of the glass sheet can be flattened at the time point when the sheet is cooled to about room temperature. Accordingly, even when the glass sheet is cooled to about room temperature, a situation in which the shape of the glass sheet becomes an improper curved shape owing to a difference in thermal expansion between the film and the glass sheet can be avoided. Thus, a glass sheet having a curved shape suitable for being subjected to heating film formation treatment can be obtained.

(b) In the above-mentioned configuration (a), it is preferred that the average of the front-back deflection differences of the five evaluation regions in the width direction be 0.15 mm or more.

With such setting, a glass sheet having a curved shape suitable for being subjected to heating film formation treatment can be more reliably obtained.

(c) In the above-mentioned configuration (a) or (b), it is preferred that the average of the front-back deflection differences of the five evaluation regions in the width direction be positive, and the front-back deflection differences of the five evaluation regions in the width direction be each −0.2 mm or more and 1.0 mm or less.

With such setting, the glass sheet has such a curved shape that the first main surface becomes a convex surface because the average of the above-mentioned front-back deflection differences is positive (a value larger than 0). In addition, variation in front-black deflection difference of the glass sheet in the width direction can be reduced because the above-mentioned front-back deflection differences are each −0.2 mm or more and 1.0 mm or less. Thus, the first main surface can be made a convex surface that is smoothly curved over the entire length or substantially the entire length in the width direction. Accordingly, when the glass sheet is used in an application where a film is formed on the first main surface to manufacture a filmed device, heating film formation treatment on the first main surface is suitably performed, and a high-quality filmed device is obtained. In addition, when the glass sheet is used in an application where a film is peeled from a filmed glass sheet obtained by forming the film on the first main surface, the heating film formation treatment is suitably performed, and the operation of peeling the film is also suitably performed.

(d) In the above-mentioned configuration (c), it is preferred that the first main surface be a guaranteed surface, and the second main surface be a non-guaranteed surface.

With such setting, a preferred aspect is achieved because a film can be formed on the guaranteed surface of the glass sheet.

(e) In any one of the above-mentioned configurations (a) to (d), it is preferred that a difference between a maximum and a minimum of the front-back deflection differences of the five evaluation regions in the width direction be 2.0 mm or less.

With such setting, the variation in front-black deflection difference of the glass sheet in the width direction can be more reliably reduced. Accordingly, also in this case, the convex surface of the glass sheet can be made a convex surface that is smoothly curved over the entire length or substantially the entire length in the width direction, and hence the same advantage as that in the above-mentioned case can be even more reliably obtained.

(f) In any one of the above-mentioned configurations (a) to (e), it is preferred that the glass sheet have a linear thermal expansion coefficient of 30×10⁻⁷/° C. or more and 50×10⁻⁷/° C. or less at from 30° C. to 380° C.

Herein, a polyimide resin film may be formed on the convex surface of the glass sheet according to the first aspect of the present invention. The linear thermal expansion coefficient of the resin film in this case falls within the above-mentioned numerical range. Accordingly, the shape of the glass sheet at the time of its cooling to about room temperature can be more reliably flattened by appropriately coping with a difference in thermal expansion between the resin film and the glass sheet.

(g) In any one of the above-mentioned configurations (a) to (f), it is preferred that the glass sheet have a thermal compaction rate of 30 ppm or less when held at 500° C. for 1 hour.

With such setting, the compaction of the glass sheet when the convex surface of the glass sheet is subjected to heating film formation treatment is suppressed. A high-definition display s particularly required to have such characteristic. Accordingly, with the configuration described herein, the glass sheet may be suitably utilized as a glass sheet for a high-definition display.

(h) In any one of the above-mentioned configurations (a) to (g), it is preferred that the glass sheet have a transmittance of 60% or more and 85% or less at a wavelength of 308 nm in a sheet thickness direction thereof.

Herein, a polyimide resin film may be formed on the convex surface of the glass sheet according to the first aspect of the present invention by heating film formation treatment. Further, in this case, the glass sheet may be used in an application where a film is peeled from a filmed glass sheet obtained by forming the film on the glass sheet. In this case, UV laser light may be used as an approach to peeling the polyimide resin film from the glass sheet. In this case, in consideration of the fact that the wavelength of the UV laser light is 308 nm, the glass sheet has an appropriate transmittance in the sheet thickness direction in the wavelength region. Thus, the operation of peeling the polyimide resin film from the glass sheet can be suitably and reliably performed.

(i) In any one of the above-mentioned configurations (a) to (h), it is preferred that the glass sheet comprise as a glass composition, in terms of mol %, 60% to 70% of SiO₂, 9.5% to 17% of Al₂O₃, 0% to 9% of B₂O₃, 0% to less than 1% of Li₂O+Na₂O+K₂O, 0% to 8% of MgO, 2% to 15% of Cao, 0% to 10% of SrO, and 0.1% to 5% of BaO.

With such setting, the liquidus viscosity and Young's modulus of the glass sheet can be increased.

(j) In any one of the above-mentioned configurations (a) to (h), it is preferred that the glass sheet comprise as a glass composition, in terms of mol %, 62% to 72% of SiO₂, 9.5% to 16% of Al₂O₃, 1% to 8% of B₂O₃, 0% to less than 1% of Li₂O+Na₂O+K₂O, 1% to 9% of MgO, 2% to 10% of Cao, 0.1% to 5% of SrO, and 0.1% to 5% of BaO.

With such setting, the liquidus viscosity and the Young's modulus can be increased.

(k) In any one of the above-mentioned configurations (a) to (h), it is preferred that the glass sheet comprise as a glass composition, in terms of mol %, 67% to 77% of SiO₂, 9% to 14% of Al₂O₃, 0% to 3% of B₂O₃, 0% to less than 1% of Li₂O+Na₂O+K₂O, 0% to 5% of MgO, 0% to 10% of Cao, 0% to 5% of SrO, and 0% to 7% of BaO.

With such setting, the strain point of the glass sheet is easily increased to 730° C. or more.

(1) According to a second aspect of the present invention, which has been devised to achieve the above-mentioned object, there is provided a method of manufacturing a glass sheet, comprising: a forming step of forming a glass ribbon from molten glass; an annealing step of annealing the glass ribbon while conveying the glass ribbon with a conveying device; and a cutting step of cutting the glass ribbon, which has been annealed, into a glass sheet having a rectangular shape, wherein the glass ribbon comprises a first main surface and a second main surface on a back side of the first main surface, and has a sheet thickness of 0.1 mm or more and 2.0 mm or less, and wherein in the annealing step, both width-direction end portions of the glass ribbon are supported from a first main surface side and a second main surface side by a plurality of roller pairs in the conveying device, and both the width-direction end portions of the glass ribbon are supported only from the second main surface side by a biased roller biased toward the first main surface of the glass ribbon at at least one site in a conveying direction of the glass ribbon in the conveying device.

With such configuration, the glass sheet according to the first aspect of the present invention described above can be appropriately manufactured. More specifically, according to the manufacturing method, there can be obtained a glass ribbon, and by extension, a glass sheet each having a curved shape that is more suitable than that in, for example, the case where both the width-direction end portions of the glass ribbon are supported from both of its main surface sides by a pair of biased rollers biased toward the first main surface of the glass ribbon at at least one site of the above-mentioned conveying path. That is, in the case where both the width-direction end portions of the glass ribbon are supported from both the main surface sides by the pair of biased rollers, even when a shape, which is curved so that the first main surface may become a convex surface in the width-direction center portion of the glass ribbon, is obtained, both the width-direction end portions are sandwiched between the pair of biased rollers to become flat shapes. In contrast, in the case where both the width-direction end portions of the glass ribbon are supported only from the second main surface side by the biased roller, both the width-direction end portions are not sandwiched, and hence not only the width-direction center portion but also both the width-direction end portions become shapes that are curved toward the first main surface. Thus, the curving degrees of the glass ribbon, and by extension, the glass sheet in their width directions can be increased. As a result, there can be obtained a glass sheet having the same advantage as that of the glass sheet according to the first aspect of the present invention described above.

(m) In the above-mentioned configuration (l), it is preferred that the first main surface be a guaranteed surface, and the second main surface be a non-guaranteed surface.

With such setting, there is obtained a glass sheet having such a curved shape that its guaranteed surface becomes a convex surface. Accordingly, a film can be formed on the guaranteed surface, and hence a preferred aspect is achieved.

(n) In the above-mentioned configuration (l) or (m), it is preferred that the biased roller have a bias amount of 1 mm or more and 20 mm or less.

With such setting, the curving degree of the glass sheet to be obtained in its width direction can be made sufficiently large.

(o) According to a third aspect of the present invention, which has been devised to achieve the above-mentioned object, there is provided a manufacturing apparatus for a glass sheet, comprising: a forming furnace configured to form, from molten glass, a glass ribbon having a first main surface and a second main surface on a back side of the first main surface; an annealing furnace configured to anneal the glass ribbon while conveying the glass ribbon with a conveying device; and a cutting device configured to cut the glass ribbon, which has been annealed, into a glass sheet having a rectangular shape, wherein the conveying device comprises: a plurality of roller pairs configured to support both width-direction end portions of the glass ribbon from a first main surface side and a second main surface side; and a biased roller, which is arranged at at least one site of a conveying path of the glass ribbon, and is biased toward the first main surface of the glass ribbon to support both the width-direction end portions of the glass ribbon only from the second main surface side.

According to the manufacturing apparatus, the manufacturing method according to the second aspect of the present invention described above can be performed, and hence substantially the same action and effect as those of the manufacturing method can be obtained.

### Advantageous Effects of Invention

According to the present invention, the glass sheet having a curved shape suitable for being subjected to heating film formation treatment and the manufacturing technology for the sheet are provided.

### BRIEF DESCRIPTION OF DRAWINGS

FIG. 1 is a plan view for illustrating a glass sheet according to an embodiment of the present invention.

FIG. 2 is a plan view for describing a method of measuring the front-back deflection difference of a sample glass, which has been cut out of the glass sheet, in its width direction.

FIG. 3 is a side view of the sample glass whose front-back deflection difference is measured by the method illustrated in FIG. 2 when viewed from a direction indicated by the arrow I.

FIG. 4 is a plan view for describing a method of measuring the front-back deflection difference of the sample glass, which has been cut out of the glass sheet, in its sheet-drawing direction.

FIG. 5 is a side view of the sample glass whose front-back deflection difference is measured by the method illustrated in FIG. 4 when viewed from a direction indicated by the arrow II.

FIG. 6 is a longitudinal side view for describing a usage example of the glass sheet according to the embodiment of the present invention.

FIG. 7 is a longitudinal side view for illustrating the schematic configuration of a manufacturing apparatus for a glass sheet according to an embodiment of the present invention.

FIG. 8 is a longitudinal front view for illustrating the schematic configuration of the manufacturing apparatus for a glass sheet according to the embodiment of the present invention, and is a view of the manufacturing apparatus of FIG. 7 when viewed from a right side.

FIG. 9 is an enlarged longitudinal side view for illustrating the main portion of the manufacturing apparatus for a glass sheet according to the embodiment of the present invention and the shape of a glass ribbon.

FIG. 10 is a horizontal plan view cut along the line D-D of FIG. 9.

FIG. 11 is an enlarged longitudinal side view for illustrating the main portion of a manufacturing apparatus for a glass sheet and the shape of a glass ribbon for describing a related-art problem.

FIG. 12 is a horizontal plan view cut along the line E-E of FIG. 11.

### DESCRIPTION OF EMBODIMENTS

A glass sheet, a manufacturing apparatus for a glass sheet, and a method of manufacturing a glass sheet according to embodiments of the present invention are described below with reference to the attached drawings.

### <Glass Sheet>

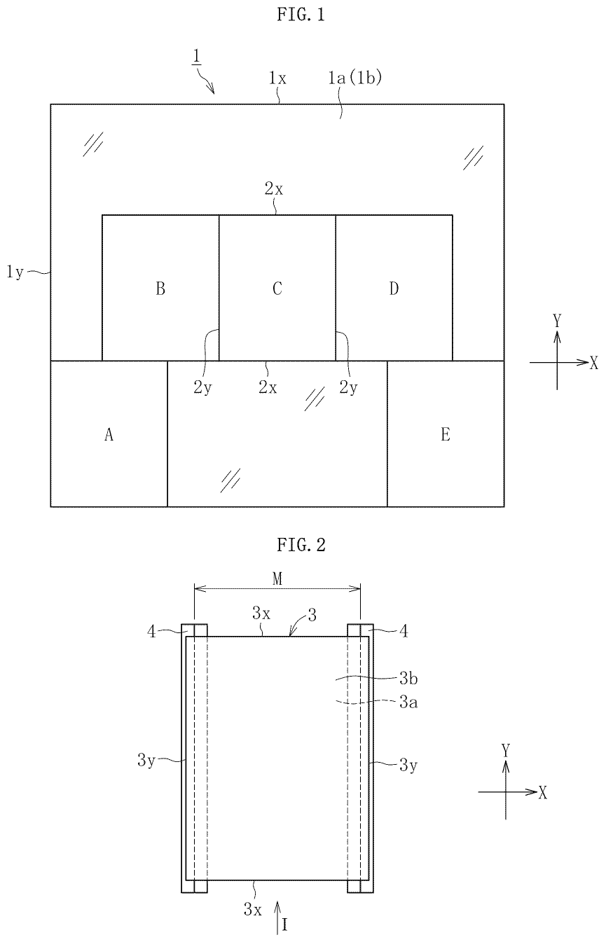

As illustrated in FIG. 1, a glass sheet 1 according to this embodiment is manufactured by a known forming method, for example: a down-draw method, such as an overflow down-draw method, a slot down-draw method, or a redraw method; or a float method. In this embodiment, a glass ribbon is formed by an overflow down-draw method, and the glass sheet 1 having a rectangular shape of a predetermined size is obtained by being cut out of the glass ribbon.

The glass sheet 1 comprises a first side 1y along a sheet-drawing direction Y and a second side 1x along a width direction X perpendicular to the sheet-drawing direction Y. The sheet-drawing direction Y of the glass sheet 1 may be observed as a streak-like stripe pattern, for example, by: applying light from a light source (e.g., a xenon light) to the glass sheet 1 in a darkroom while adjusting the angle of the glass sheet 1; and projecting the light that has passed through the sheet on a screen. Accordingly, even in the glass sheet 1 after the cutting out, the sheet-drawing direction Y at the time of its forming can be identified.

The first main surface of the glass sheet 1 is used as a guaranteed surface 1a, and the second main surface thereof on the back side of the first main surface is used as a non-guaranteed surface 1b. The guaranteed surface 1a is guaranteed to have predetermined quality, and its non-contact state is maintained to the extent possible in each step, such as the conveyance or processing of the glass sheet 1. In contrast, the non-guaranteed surface 1b is used as a contact surface with which a conveying device or the like is brought into contact at the time of each step, such as the conveyance or the processing.

The glass sheet 1 is, for example, a low-alkali glass sheet for a display. The term “display” as used herein refers to, for example, a liquid crystal display, an OLED display, or a plastic OLED display. In addition, the term “low-alkali glass” means glass in which the amount of an alkali component (alkali metal oxide) is small, or glass that is substantially free of any alkali component.

A specific example of the composition of the low-alkali glass is, in terms of mol %, 60% to 75% of SiO₂, 5% to 20% of Al₂O₃, 0% to 15% of B₂O₃, 0% to less than 1% of Li₂O+Na₂O+K₂O (total content of Li₂O, Na₂O, and K₂O), 0% to 10% of MgO, 0% to 15% of Cao, 0% to 10% of SrO, and 0% to 10% of Bao. Of those, the following glass composition examples particularly preferred.

A first glass composition example is, in terms of mol %, 60% to 70% of SiO₂, 9.5% to 17% (particularly 11% to 15%) of Al₂O₃, 0% to 9% (particularly 5% to 7%) of B₂O₃, 0% to less than 1% (particularly 0% to 0.5%) of Li₂O+Na₂O+K₂O, 0% to 8% (particularly 2% to 6%) of MgO, 2% to 15% (particularly 6% to 11%) of Cao, 0% to 10% (particularly 0.1% to 3%) of SrO, and 0.1% to 5% of BaO. With such setting, the liquidus viscosity and Young's modulus of the glass sheet can be increased.

A second glass composition example is, in terms of mols, 62% to 72% of SiO₂, 9.5% to 16% (particularly 11% to 15%) of Al₂O₃, 1% to 8% (particularly 2% to 4%) of B₂O₃, 0% to less than 1% (particularly 0% to 0.5%) of Li₂O+Na₂O+K₂O, 1% to 9% (particularly 4% to 8%) of MgO, 2% to 10% (particularly 3% to 8%) of CaO, 0.1% to 5% (particularly 1% to 3%) of SrO, and 0.1% to 5% (particularly 1% to 3%) of BaO. With such setting, the liquidus viscosity and the Young's modulus can be increased.

A third glass composition example is, in terms of mol %, 67% to 77% of SiO₂, 9% to 14% of Al₂O₃, 0% to 3% (particularly 0% to less than 1%) of B₂O₃, 0% to less than 1% (particularly 0% to 0.5%) of Li₂O+Na₂O+K₂O, 0% to 5% (particularly 2% to 5%) of MgO, 0% to 10% (particularly 6% to 9%) of CaO, 0% to 5% of SrO, and 0% to 7% (particularly 3% to 6%) of BaO. With such setting, the strain point of the glass sheet is easily increased to 730° C. or more.

SiO₂ is a component for forming the skeleton of the glass, and is a component that increases the strain point thereof. Further, SiO₂ is a component that improves the acid resistance thereof. Meanwhile, when the content of SiO₂ is large, the viscosity of the glass at high temperature increases, and hence the meltability thereof reduces. In addition, a devitrified crystal such as cristobalite is liable to precipitate, and hence the liquidus temperature thereof increases.

Al₂O₃ is a component for forming the skeleton of the glass, and is a component that increases the strain point thereof. Further, Al₂O₃ is a component that increases the Young's modulus thereof. Meanwhile, when the content of Al₂O₃ is large, a mullite- or feldspar-based devitrified crystal is liable to precipitate, and hence the liquidus temperature of the glass increases.

B₂O₃ is a component that improves the meltability and devitrification resistance of the glass. Meanwhile, when the content of B₂O₃ is large, the strain point and Young's modulus of the glass reduce, and hence an increase in thermal compaction rate thereof and a pitch shift in a panel manufacturing process are liable to occur.

MgO is a component that reduces the viscosity of the glass at high temperature to improve the meltability thereof, and increases the Young's modulus thereof. Meanwhile, when the content of MgO is large, the precipitation of mullite, a Mg- or Ba-derived crystal, and a cristobalite crystal is promoted. In addition, when the content of MgO is large, the strain point of the glass remarkably reduces.

CaO is a component that reduces the viscosity of the glass at high temperature to remarkably improve the meltability thereof without reducing the strain point thereof. In addition, a raw material for introducing Cao is relatively inexpensive among those for alkaline earth metal oxides, and hence Cao is a component that achieves a reduction in raw material cost. Further, CaO is a component that increases the Young's modulus of the glass. In addition, CaO has a suppressing effect on the precipitation of the devitrified crystal containing Mg described above. Meanwhile, when the content of Cao is large, a devitrified crystal of anorthite is liable to precipitate, and the density of the glass is liable to increase.

SrO is a component that suppresses the phase separation of the glass and increases the devitrification resistance thereof. Further, SrO is a component that reduces the viscosity of the glass at high temperature to improve the meltability thereof without reducing the strain point thereof. However, when the content of SrO is large, in a glass system comprising CaO in a large amount, a feldspar-based devitrified crystal is liable to precipitate, and the devitrification resistance is liable to reduce. Further, when the content of SrO is large, there is a tendency that the density of the glass increases or the Young's modulus thereof reduces.

BaO is a component that has a high suppressing effect on the precipitation of a mullite-based or anorthite-based devitrified crystal, among alkaline earth metal oxides. Meanwhile, when the content of BaO is large, the density of the glass is liable to increase, the Young's modulus thereof is liable to reduce, and the viscosity thereof at high temperature is liable to excessively increase to reduce the meltability thereof.

The length of the first side 1y and length of the second side 1x of the glass sheet 1 are each 1,000 mm or more, preferably 1, 200 mm or more, more preferably 1, 500 mm or more. In addition, those lengths are each 4,000 mm or less, preferably 3,000 mm or less, more preferably 2,000 mm. In this embodiment, the length of the first side 1y is 1, 500 mm, and the length of the second side 1x is 1,850 mm.

The sheet thickness of the glass sheet 1 is 0.1 mm or more, preferably 0.2 mm or more, more preferably 0.3 mm or more, still more preferably 0.4 mm or more, most preferably 0.5 mm or more. In addition, the sheet thickness of the glass sheet 1 is 2.0 mm or less, preferably 1.8 mm or less, more preferably 1.5 mm or less, still more preferably 1.2 mm or less, most preferably 0.9 mm or less.

The shape of the glass sheet 1, which is the shape of the glass sheet 1 along the width direction X herein, can be evaluated by using a front-back deflection difference. In the following, a method of evaluating the shape of the glass sheet 1 along the width direction X with a front-back deflection difference X1−X2 is described.

As illustrated in FIG. 1, five evaluation regions A, B, C, D, and E each having a rectangular shape whose positions in the width direction X are different from each other are set for the one glass sheet 1. The respective evaluation regions A to E are sequentially set from one end side in the width direction X. The evaluation regions B, C, and D are arranged side by side in a line and without any gap along the width direction X. In addition, the positions of the evaluation regions A and E in the sheet-drawing direction Y are different from those of the evaluation regions B to D. The position of the evaluation region A in the width direction X partially overlaps with that of the evaluation region B, and the position of the evaluation region E in the width direction X partially overlaps with that of the evaluation region D. The five evaluation regions A to E in this embodiment are set from one end side of the glass sheet 1 in the width direction X to the other end side thereof over the entire length. Herein, the five evaluation regions A to E each have a rectangular shape in which the length of a side 2x along the width direction X is 400 mm, and the length of a side 2y along the sheet-drawing direction Y is 500 mm.

A sample glass 3 (see FIG. 2 and FIG. 4), which is a glass piece whose position and size correspond to those of each of the evaluation regions A to E, is collected from the glass sheet 1, and the five sample glasses 3 corresponding to the evaluation regions A to E are obtained for the one glass sheet 1. In other words, the sample glass 3 comprises a side 3y along the sheet-drawing direction Y, which corresponds to the side 2y of each of the evaluation regions A to E, and a side 3x along the width direction X, which corresponds to the side 2x of each of the evaluation regions A to E.

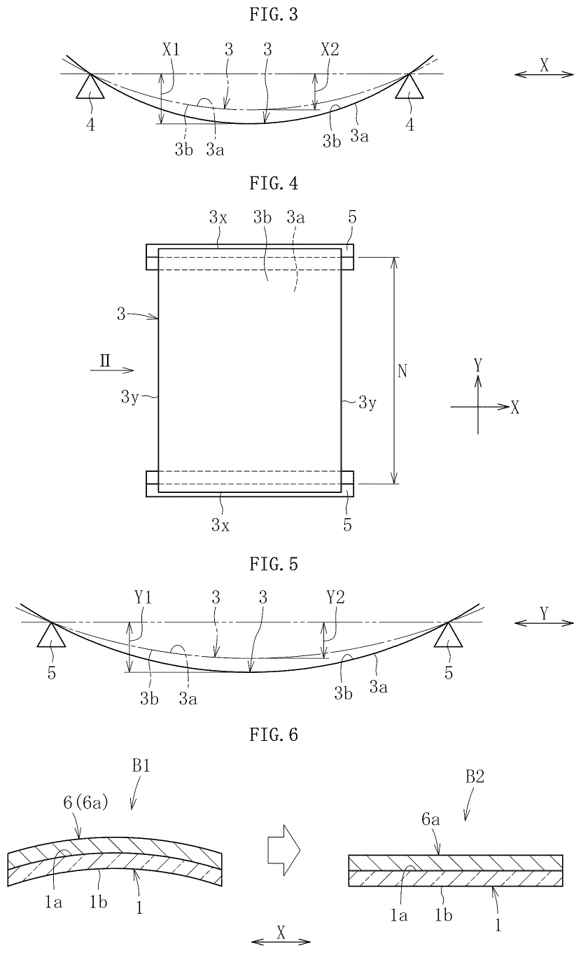

After the five sample glasses 3 have been prepared as described above, the front-back deflection difference X1−X2 of each of the sample glasses 3 in the width direction X is measured. Specifically, as illustrated in FIG. 2, both the end portions of the sample glass 3 in the width direction X are supported by a pair of supporting members 4 under a state in which the guaranteed surface 3a (surface on the same side as that of the guaranteed surface 1a of the glass sheet 1) of the sample glass 3 is directed downward. At this time, in the case where the length of the side 3x along the width direction X is 400 mm, and the length of the side 3y along the sheet-drawing direction Y is 500 mm, the supporting span M of the sample glass 3 by the pair of supporting members 4 is set to 380 mm, and in any case except the foregoing, the span is set to a value obtained by subtracting 20 mm from the length of the side 3x of the sample glass 3 along the width direction X. In this state, as illustrated in FIG. 3, the size of the first deflection X1 (state indicated by a solid line in the figure) of the sample glass 3 in the width direction X is measured. At the time of the measurement, the first deflection X1 is measured for each of the two parallel sides 3x of the sample glass 3 along the width direction X, and the larger numerical value out of both the measured values is adopted as the first deflection X1. The size of the first deflection X1 thus adopted is converted into the first deflection X1 when the supporting span M is 350 mm. For example, when the supporting span M is M1 (arbitrary value) mm, the conversion is performed by using the expression “X1×(350/M1)”.

Similarly, the sample glass 3 is turned inside out, and both the end portions of the sample glass 3 in the width direction X are supported by the pair of supporting members 4 under a state in which the non-guaranteed surface 3b (surface on the same side as that of the non-guaranteed surface 1b of the glass sheet 1) of the sample glass 3 is directed downward. In this state, as illustrated in FIG. 3, the size of the second deflection X2 (state indicated by a dash-dotted line in the figure) of the sample glass 3 in the width direction X is measured. Also at the time of the measurement, the second deflection X2 is measured for each of the two parallel sides 3x of the sample glass 3 along the width direction X, and the larger numerical value out of both the measured values is adopted as the second deflection X2. The size of the second deflection X2 thus adopted is converted into the second deflection X2 when the supporting span M is 350 mm.

After the first deflection X1 and the second deflection X2 have been measured as described above, the front-back deflection difference X1−X2 in the width direction X is obtained by subtracting the second deflection X2 from the first deflection X1.

The shapes of the respective evaluation regions A to E in the width direction X can be grasped by performing the foregoing operations on all the sample glasses 3 corresponding to the respective evaluation regions A to E. For example, when the first deflection X1 is larger than the second deflection X2 as illustrated in FIG. 3, and hence the front-back deflection difference X1−X2 becomes positive (a numerical value larger than 0), the shape of the deflection of the sample glass 3 out of the glass sheet 1 in the width direction X is such that the guaranteed surface 3a becomes a convex surface, and the size of the convex surface can be evaluated by the absolute value of the front-back deflection difference X1−X2. Meanwhile, when the first deflection X1 is smaller than the second deflection X2, and hence the front-back deflection difference X1−X2 becomes negative (a value smaller than 0) (not shown), the shape of the deflection of the sample glass 3 out of the glass sheet 1 in the width direction X is such that the guaranteed surface 3a becomes a concave surface, and the size of the concave surface can be evaluated by the absolute value of the front-back deflection difference X1−X2. Herein, in the glass sheet 1, when an arbitrary linear region (section) along the width direction X is observed, annealing conditions at the respective points on the linear region can be regarded as being substantially the same even when the positions of the points in the sheet-drawing direction Y are different from each other. Accordingly, the shape of the entirety of the glass sheet 1 in the width direction X can be grasped merely by determining the front-back deflection differences X1−X2 in the sample glasses 3 corresponding to the respective evaluation regions A to E.

The shape of the glass sheet 1 along the sheet-drawing direction Y can be evaluated by a front-back deflection difference Y1−Y2 in accordance with the same procedure as that described above. The evaluation method is described below.

After the five sample glasses 3 corresponding to the evaluation regions A to E illustrated in FIG. 1 have been prepared, the front-back deflection difference Y1−Y2 of each of the sample glasses 3 in the sheet-drawing direction Y is measured. The sample glasses 3 to be prepared may be the sample glasses 3 used at the time of the evaluation of the shape along the width direction X. Specifically, as illustrated in FIG. 4, both the end portions of each of the sample glasses 3 in the sheet-drawing direction Y are supported by a pair of supporting members 5 under a state in which the guaranteed surface 3a of the sample glass 3 is directed downward. At this time, in the case where the length of the side 3y along the sheet-drawing direction Y is 500 mm, and the length of the side 3x along the width direction X is 400 mm, the supporting span N of the sample glass 3 by the pair of supporting members 5 is set to 480 mm, and in any case except the foregoing, the span is set to a value obtained by subtracting 20 mm from the length of the side 3y of the sample glass 3 along the sheet-drawing direction Y. In this state, as illustrated in FIG. 5, the size of the first deflection Y1 (state indicated by a solid line in the figure) of the sample glass 3 in the sheet-drawing direction Y is measured. At the time of the measurement, the first deflection Y1 is measured for each of the two parallel sides 3y of the sample glass 3 along the sheet-drawing direction Y, and the larger numerical value out of both the measured values is adopted as the first deflection Y1. The size of the first deflection Y1 thus adopted is converted into the first deflection Y1 when the supporting span N is 350 mm.

Similarly, the sample glass 3 is turned inside out, and both the end portions of the sample glass 3 in the sheet-drawing direction Y are supported by the pair of supporting members 5 under a state in which the non-guaranteed surface 3b of the sample glass 3 is directed downward. In this state, as illustrated in FIG. 5, the size of the second deflection Y2 (state indicated by a dash-dotted line in the figure) of the sample glass 3 in the sheet-drawing direction Y is measured. At the time of the measurement, the second deflection Y2 is measured for each of the two parallel sides 3y of the sample glass 3 along the sheet-drawing direction Y, and the larger numerical value out of both the measured values is adopted as the second deflection Y2. The size of the second deflection Y2 thus adopted is converted into the second deflection Y2 when the supporting span N is 350 mm.

After the first deflection Y1 and the second deflection Y2 have been measured as described above, the front-back deflection difference Y1−Y2 in the sheet-drawing direction Y is obtained by subtracting the second deflection Y2 from the first deflection Y1.

The shapes of the respective evaluation regions A to E in the sheet-drawing direction Y can be grasped by performing the foregoing operations on all the sample glasses 3 corresponding to the respective evaluation regions A to E. For example, when the first deflection Y1 is larger than the second deflection Y2 as illustrated in FIG. 5, and hence the front-back deflection difference Y1−Y2 becomes positive, the shape of the deflection of the sample glass 3 out of the glass sheet 1 in the sheet-drawing direction Y is such that the guaranteed surface 3a becomes a convex surface, and the size of the convex surface can be evaluated by the absolute value of the front-back deflection difference Y1−Y2. Meanwhile, when the first deflection Y1 is smaller than the second deflection Y2, and hence the front-back deflection difference Y1−Y2 becomes negative (not shown), the shape of the deflection of the sample glass 3 out of the glass sheet 1 in the sheet-drawing direction Y is such that the guaranteed surface 3a becomes a concave surface, and the size of the concave surface can be evaluated by the absolute value of the front-back deflection difference Y1−Y2. Herein, in the glass sheet 1, when an arbitrary linear region (section) along the width direction X is observed, annealing conditions at the respective points on the linear region can be regarded as being substantially the same even when the positions of the points in the sheet-drawing direction Y are different from each other. Accordingly, the shape of the entirety of the glass sheet 1 in the sheet-drawing direction Y can be grasped merely by determining the front-back deflection differences Y1−Y2 in the sample glasses 3 corresponding to the respective evaluation regions A to E.

When the shape of the glass sheet 1 according to this embodiment is evaluated by the above-mentioned front-back deflection difference, the shape has such shape quality as described below.

That is, in the glass sheet 1, the absolute value of the average of the front-back deflection differences X1−X2 of the sample glasses corresponding to the five evaluation regions A to E in the width direction X is 0.06 mm or more and 0.8 mm or less. The lower limit value of the absolute value is preferably 0.1 mm or more, 0.15 mm or more, or 0.17 mm or more, more preferably 0.18 mm or more, still more preferably 0.2 mm or more. Meanwhile, the upper limit value of the absolute value is preferably 0.6 mm or less, more preferably 0.5 mm or less, still more preferably 0.4 mm or less.

In addition, in the glass sheet 1, the average of the front-back deflection differences X1−X2 of the sample glasses corresponding to the five evaluation regions A to E in the width direction X is positive. In addition, in the glass sheet 1, the front-back deflection differences X1−X2 of the sample glasses corresponding to the five evaluation regions A to E in the width direction X are each −0.2 mm or more and 1.0 mm or less. The lower limit value of each of the front-back deflection differences X1−X2 is preferably-0.1 mm or more, more preferably 0 mm or more, still more preferably 0.1 mm or more. Meanwhile, the upper limit value of the front-back deflection difference X1−X2 is preferably 0.9 mm or less, more preferably 0.85 mm or less, still more preferably 0.8 mm or less.

Further, in the glass sheet 1, a difference between the maximum and minimum of the front-back deflection differences X1−X2 of the sample glasses corresponding to the five evaluation regions A to E in the width direction X is 2.0 mm or less. The difference is preferably 1.5 mm or less, more preferably 1.3 mm or less, still more preferably 1.0 mm or less.

Under the foregoing circumstances, the average of the front-back deflection differences X1−X2 is positive, and hence the glass sheet 1 has such a curved shape that the guaranteed surface 1a becomes a convex surface in the width direction X. Moreover, the curving degree of the convex surface is large because the numerical value of each of the front-back deflection differences X1−X2 is large. In addition, the convex surface is smoothly curved over the entire length or substantially the entire length in the width direction X in an even more reliable manner because the difference between the maximum and minimum of the front-back deflection differences X1−X2 is small. Such shape of the glass sheet 1 along the width direction X covers the entire length in the sheet-drawing direction Y.

In FIG. 6, a usage example of the glass sheet 1 is schematically illustrated. In a first usage example, as represented by reference symbol B1 in the figure, the guaranteed surface 1a of the glass sheet 1 is subjected to heating film formation treatment. More specifically, a resin film material 6 such as polyimide is applied to the guaranteed surface 1a of the glass sheet 1, and is dried through deaeration. After that, the film material 6 is cured through sintering to form a resin film 6a. Then, when the resultant is cooled to about room temperature after the sintering, the shapes of the glass sheet 1 and the resin film 6a are flattened as represented by reference symbol B2 in the figure (in the illustrated example, the shapes become flat shapes). After that, the resin film 6a is peeled from the glass sheet 1 with UV laser light, and the resin film 6a after the peeling is used in the manufacture of an electronic device such as a display. In this case, at the time of the peeling of the resin film 6a, a peeling operation is suitably and reliably performed because the shape of the glass sheet 1 is flattened.

In addition, in a second usage example, as represented by reference symbol B1 in the figure, the film 6a, such as an organic film (including a resin film) or an inorganic film (including a metal film), is formed by subjecting the guaranteed surface 1a of the glass sheet 1 to heating film formation treatment in accordance with the same procedure as that described above. After that, as represented by reference symbol B2 in the figure, the shape of the glass sheet 1 is flattened by being cooled to about room temperature in the same manner as that described above. Then, the glass sheet 1 with the film 6a thus obtained is used in the manufacture of an electronic device such as a display. The glass sheet 1 with the film 6a has high quality because the sheet has a flattened shape. In relation to those usage examples, the glass sheet 1 has such characteristics as described below.

The linear thermal expansion coefficient of the glass sheet 1 at from 30° C. to 380° C. is set to 30×10⁻⁷/° C. or more and 50×10⁻⁷/° C. or less. Such setting is convenient when the polyimide resin film 6a is formed on the guaranteed surface 1a of the glass sheet 1 by heating film formation treatment. That is, the linear thermal expansion coefficient of the polyimide resin film 6a falls within the above-mentioned numerical range, and hence the shape of the glass sheet 1 at the time of its cooling to about room temperature can be more reliably flattened by appropriately coping with a difference in thermal expansion between the resin film 6a and the glass sheet 1.

The thermal compaction rate of the glass sheet 1 at the time of its holding at 500° C. for 1 hour is set to 30 ppm or less. With such setting, the compaction of the glass sheet 1 when the guaranteed surface 1a of the glass sheet 1 is subjected to heating film formation treatment is suppressed. A high-definition display is particularly required to have such characteristic. Accordingly, the glass sheet 1 may be suitably utilized for a high-definition display. The “thermal compaction rate” is measured by such a method as described below. First, a strip-shaped sample measuring 160 mm by 30 mm is prepared as a sample for measurement. A marking is made at a position distant from an end of the strip-shaped sample in its long side direction by from about 20 mm to about 40 mm with #1000 waterproof abrasive paper, and the sample is bent and broken in a direction perpendicular to the marking to provide two test pieces. One of the test pieces obtained as a result of the bend-breaking is subjected to heat treatment under predetermined conditions. After that, the other test piece that has not been subjected to any heat treatment and the test piece subjected to the heat treatment are fixed side by side with a tape or the like. The predetermined heat treatment is treatment comprising: increasing the temperature of the test piece from normal temperature to 500° C. at 5° C./min; holding the test piece at 500° C. for 1 hour; and then decreasing the temperature from 500° C. to normal temperature at 5° C./min. Under this state, the position shift amounts (ΔL1 and ΔL2) of the marking are read with a laser microscope, and the thermal compaction rate is calculated from the following equation (4).

Thermal compaction rate [ppm]=(ΔL1 [μm]+ΔL2 [μm])/160×10⁻³ (4)

The thermal compaction rate is preferably 30 ppm or less or 20 ppm or less, particularly preferably 15 ppm or less. With such setting, when the glass sheet 1 is used in the manufacture of a high-definition display, an inconvenience such as a pattern shift hardly occurs. When the thermal compaction rate is excessively low, the production efficiency of the glass sheet 1 is liable to reduce. Accordingly, the thermal compaction rate is preferably 1 ppm or more, 2 ppm or more, 3 ppm or more, or 4 ppm or more, particularly preferably 5 ppm or more.

The transmittance of the glass sheet 1 at wavelength of 308 nm in its sheet thickness direction is set to 60% or more and 85% or less. The transmittance may be measured with a spectrophotometer.

Such setting is convenient when the polyimide resin film 6a is formed on the guaranteed surface 1a of the glass sheet 1 by heating film formation treatment, and the resin film 6a is peeled with UV laser light. That is, the wavelength of the UV laser light is 308 nm, and hence the glass sheet 1 has an appropriate transmittance in the sheet thickness direction in the same wavelength region as that of the light. Thus, the operation of peeling the polyimide resin film 6a from the glass sheet 1 can be even more suitably and reliably performed.

Although the glass sheet 1 according to the above-mentioned embodiment has such a curved shape that the guaranteed surface 1a becomes a convex surface in the width direction X, the sheet may have such a curved shape that the guaranteed surface 1a becomes a convex surface in each of both the width direction X and the sheet-drawing direction Y. The shape of such glass sheet 1 along the sheet-drawing direction Y can be evaluated by the front-back deflection difference Y1−Y2 through use of the above-mentioned approach. In this case, the average of the front-back deflection differences Y1−Y2 of the five evaluation regions A to E of the glass sheet 1 in the sheet-drawing direction Y is preferably positive. In addition, the absolute value of the average of the front-back deflection differences Y1−Y2 of the five evaluation regions A to E in the sheet-drawing direction Y is preferably the same as the absolute value of the average of the front-back deflection differences X1−X2 thereof in the width direction X described above.

### <Manufacturing Apparatus for Glass Sheet>

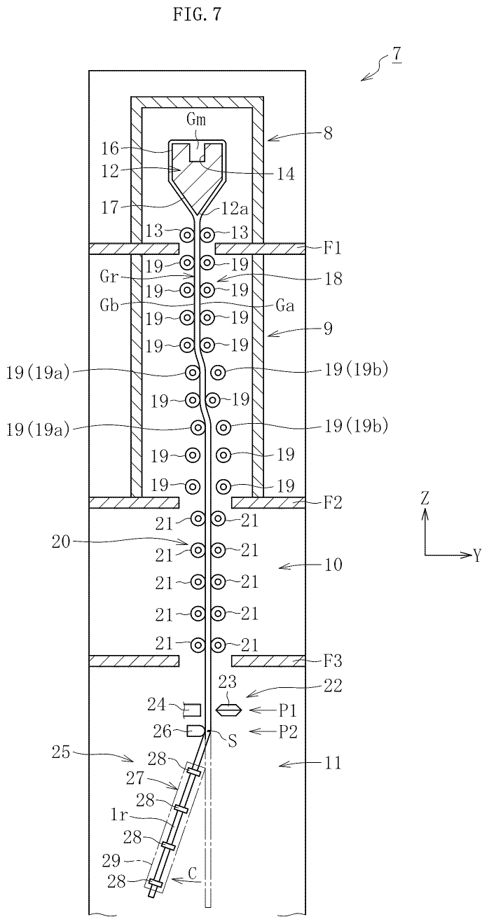

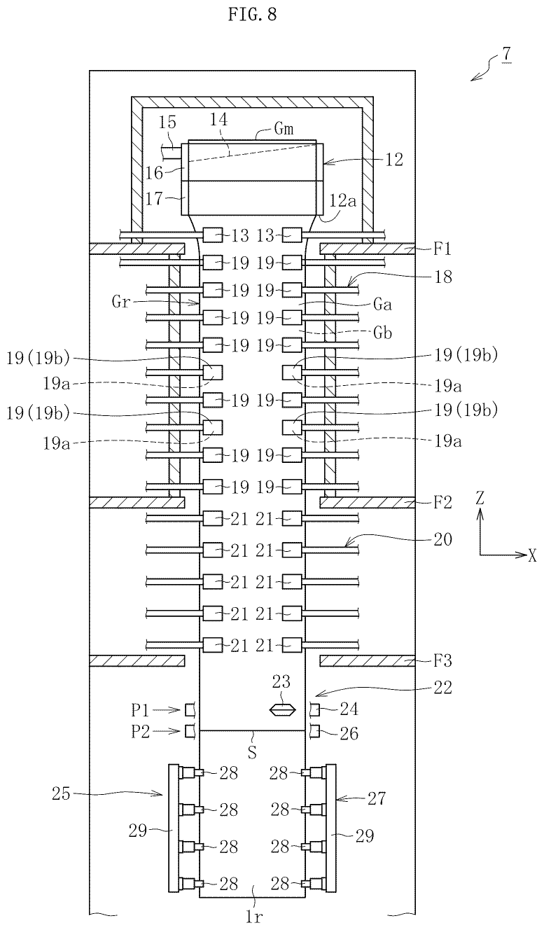

As illustrated in each of FIG. 7 and FIG. 8, a manufacturing apparatus 7 for the glass sheet 1 according to this embodiment comprises: a forming furnace 8; an annealing furnace 9 positioned below the forming furnace 8; a cooling zone 10 positioned below the annealing furnace 9; and a cutting device 11 positioned below the cooling zone 10. The forming furnace 8 and the annealing furnace 9, the annealing furnace 9 and the cooling zone 10, and the cooling zone 10 and the cutting device 11 are partitioned from each other by partitioning members (e.g., the floor surfaces of a building) F1, F2, and F3 comprising opening portions (e.g., slits) through which a glass ribbon Gr passes, respectively.

The forming furnace 8 is a region for forming the glass ribbon Gr from molten glass Gm by an overflow down-draw method. A forming body 12, which is configured to form the glass ribbon Gr from the molten glass Gm, and edge rollers 13, which are configured to cool both the end portions of the glass ribbon Gr formed in the forming body 12 in the width direction X, are arranged in the forming furnace 8.

A groove portion (overflow groove) 14 formed along the width direction is arranged in the top of the forming body 12. A supplying pipe 15 is connected to one end side of the groove portion 14. The molten glass Gm is supplied into the groove portion 14 through the supplying pipe 15. A method of supplying the molten glass Gm is not limited thereto. For example, the molten glass Gm may be supplied from both the end sides of the groove portion 14, or the molten glass Gm may be supplied from above the groove portion 14.

Both the outer surfaces of the forming body 12 each comprise: a vertical surface portion 16 having a planar shape along a vertical direction; and an inclined surface portion 17 having a planar shape that is continuous with the lower portion of the vertical surface portion 16 and is inclined with respect to the vertical direction. The respective vertical surface portions 16 are flat surfaces parallel to each other. The respective inclined surface portions 17 are flat surfaces that are inclined so as to approach each other as the surfaces advance downward. In other words, the forming body 12 has a wedge shape tapering downward when viewed from a side through the formation of the respective inclined surface portions 17, and a corner portion in which the respective inclined surface portions 17 intersect each other forms the lower end portion 12a of the forming body 12. The shapes of the vertical surface portions 16 may be changed to, for example, inclined surfaces or curved surfaces, or the portions may be omitted.

The edge rollers 13 are formed as a roller pair configured to sandwich each end portion of the glass ribbon Gr in the width direction directly below the forming body 12. The edge rollers 13 are cantilever-type rollers, and their insides are cooled at all times in a forming step. Accordingly, the edge rollers 13 are sometimes referred to as “cooling rollers.”

The annealing furnace 9 is a region for reducing the warpage and internal strain of the glass ribbon Gr. A first conveying device 18 is arranged in the annealing furnace 9. The first conveying device 18 comprises annealer rollers 19. The annealer rollers 19 are basically formed as a roller pair configured to sandwich both the width-direction end portions of the glass ribbon Gr. Although the annealer rollers 19 may be double-supported-type rollers arranged so as to straddle the entire region of the glass ribbon Gr in the width direction, the rollers are cantilever-type rollers in this embodiment. The annealer rollers 19 are arranged in a plurality of stages (9 stages in the illustrated example) on the conveying path of the glass ribbon Gr along a vertical direction.

The cooling zone 10 is a region for cooling the glass ribbon Gr to about room temperature. A second conveying device 20 is arranged in the cooling zone 10. The second conveying device 20 comprises conveying rollers 21. The conveying rollers 21 are formed as a roller pair configured to sandwich both the width-direction end portions of the glass ribbon Gr. Although the conveying rollers 21 may be double-supported-type rollers arranged so as to straddle the entire region of the glass ribbon Gr in the width direction, the rollers are cantilever-type rollers in this embodiment. The conveying rollers 21 are arranged in a plurality of stages (5 stages in the illustrated example) in the vertical direction.

The cutting device 11 comprises a scribe line-forming device 22. The scribe line-forming device 22 is a device configured to form a scribe line S in the first main surface Ga of the glass ribbon Gr, which has descended from the cooling zone 10, at a scribe line-forming position P1. In this embodiment, the scribe line-forming device 22 comprises: a wheel cutter 23 configured to form, in the first main surface Ga of the glass ribbon Gr, the scribe line S along the width direction; and a supporting member 24 (e.g., a supporting bar or a supporting roller) configured to support the second main surface Gb of the glass ribbon Gr at a position corresponding to the wheel cutter 23. The wheel cutter 23 and the supporting member 24 are configured to form the scribe line S in the entire region or part of the glass ribbon Gr in the width direction while moving following the glass ribbon Gr continuously moving downward. The scribe line S may be formed by, for example, applying laser light.

The cutting device 11 further comprises a bend-breaking device 25. The bend-breaking device 25 is a device configured to bend and break the glass ribbon Gr along the scribe line S at a bend-breaking position P2 arranged below the scribe line-forming position P1 to cut out a glass sheet 1r. In this embodiment, the bend-breaking device 25 comprises: a bend-breaking member 26 configured to be brought into abutment with the region having formed therein the scribe line S from the second main surface Gb side; and a gripping mechanism 27 configured to grip the lower region of the glass ribbon Gr at a position below the bend-breaking position P2. The bend-breaking member 26 comprises a plate-like body having a contact surface to be brought into contact with the entire region or part of the glass ribbon Gr in the width direction. The gripping mechanism 27 comprises: chucks 28 arranged at a plurality of sites in the vertical direction in both the width-direction end portions of the glass ribbon Gr; and an arm 29 configured to hold the plurality of chucks 28 in both the width-direction end portions.

The bend-breaking member 26 and the gripping mechanism 27 perform such operations as described below. First, after the plurality of chucks 28 have gripped the glass ribbon Gr, the arm 29 moves the plurality of chucks 28 following the descent of the glass ribbon Gr. At this time, the bend-breaking member 26 also moves following the descent of the glass ribbon Gr. During the performance of those movements, the arm 29 performs an operation (operation in a C direction illustrated in FIG. 1) for curving the glass ribbon Gr through use of the bend-breaking member 26 as a fulcrum. Thus, a bending stress is applied to the scribe line S and a vicinity thereof to bend and break the glass ribbon Gr in the width direction along the scribe line S. As a result of cutting by the bend-breaking, the glass sheet 1r is cut out of the glass ribbon Gr.

In this embodiment, the glass ribbon Gr and the glass sheet 1r obtained by the manufacturing apparatus 7 each have, in both of its end portions in the width direction X, selvage portions each having a thickness larger than that of its center portion in the width direction X. The selvage portions are formed by an influence of, for example, compaction in a forming process. When the selvage portions are removed from the glass sheet 1r in a subsequent step, the above-mentioned glass sheet 1 is obtained. The guaranteed surface (first main surface) 1a of the glass sheet 1 and the first main surface Ga of the glass ribbon Gr are surfaces on the same side in the sheet thickness direction.

Herein, the first conveying device 18 arranged in the above-mentioned annealing furnace 9 is described in detail. As illustrated in FIG. 7, out of the annealer rollers 19 arranged in 9 stages in the vertical direction, the annealer rollers 19 in the first stage to the fourth stage from above, and the annealer rollers 19 in the sixth stage from above support both the width-direction end portions of the glass ribbon Gr from its first main surface Ga side and second main surface Gb side. Accordingly, those annealer rollers 19 sandwich both the width-direction end portions of the glass ribbon Gr.

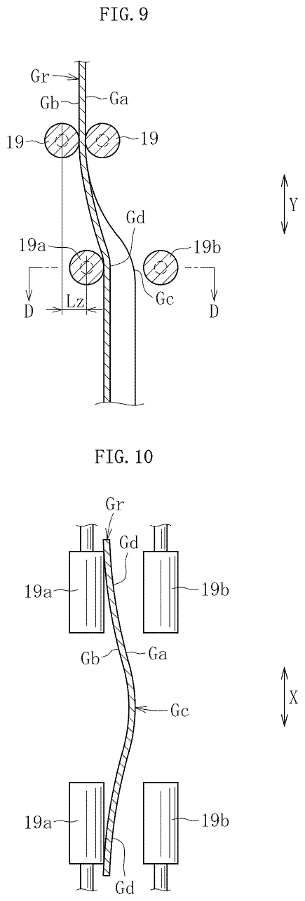

Meanwhile, in each of the annealer rollers 19 in the fifth stage and the seventh stage from above, the annealer roller 19 present on the second main surface Gb side of the glass ribbon Gr is biased toward the first main surface Ga (the annealer roller 19 is hereinafter referred to as “biased roller 19a”). In addition, both the width-direction end portions of the glass ribbon Gr are supported only from the second main surface Gb side by those biased rollers 19a. In other words, those biased rollers 19a push both the width-direction end portions of the glass ribbon Gr only from the second main surface Gb side. The biased roller 19a in the fifth stage from above is biased toward the first main surface Ga with respect to the annealer roller 19 present on the second main surface Gb side in the annealer rollers 19 in the fourth stage from above. The biased roller 19a in the seventh stage from above is biased toward the first main surface Ga with respect to the annealer roller 19 present on the second main surface Gb side in the annealer rollers 19 in the sixth stage from above. As illustrated in FIG. 9, a bias amount Lz in which each of those biased rollers 19a is biased toward the first main surface Ga is set to 1 mm or more and 20 mm or less with respect to the upper nearest annealer roller 19. The lower limit value of the bias amount Lz is more preferably 3 mm or more, still more preferably 5 mm or more. In addition, the upper limit value of the bias amount Lz is more preferably 15 mm or less, still more preferably 10 mm or less. In this case, as illustrated in FIG. 7, the annealer roller 19 present on the second main surface Gb side in the annealer rollers 19 in the sixth stage from above is biased toward neither the first main surface Ga nor the second main surface Gb with respect to the biased roller 19a in the fifth stage from above.

Further, as illustrated in FIG. 7 and FIG. 9, biased counter rollers 19b are arranged at positions facing the two biased rollers 19a in the sheet thickness direction of the glass ribbon Gr. Those biased counter rollers 19b are separated from both the width-direction end portions of the glass ribbon Gr to be out of contact with the first main surface Ga. In this embodiment, the annealer rollers 19 in the eighth stage and the ninth stage from above do not sandwich both the width-direction end portions of the glass ribbon Gr, and in the illustrated example, the rollers are separated from both the width-direction end portions of the glass ribbon Gr to be out of contact with both the first main surface Ga and the second main surface Gb. Accordingly, in the annealing furnace 9, the annealer rollers 19 arranged below the biased roller 19a and the biased counter roller 19b arranged in the lowermost portion do not sandwich the glass ribbon Gr.

The two biased rollers 19a are preferably arranged in a region where the temperature of the glass ribbon Gr becomes from the strain point to softening point thereof. Alternatively, the two biased rollers 19a are preferably arranged in a region where the viscosity of the glass ribbon Gr becomes from 10^{14.5} dPa·s to 10^{7.6} dPa·s. In other words, each of the two biased rollers 19a is preferably arranged below the vertical-direction center position of the conveying path in the annealing furnace 9. The biased rollers 19a may be arranged at one site of the conveying path in the annealing furnace 9, or may be arranged at three or more sites thereof instead of being arranged at two sites of the conveying path like the illustrated example. Also in such case, those biased rollers 19a are preferably arranged below the vertical-direction center position of the conveying path in the annealing furnace 9. In addition, when the biased rollers 19a are arranged at two sites of the conveying path in the annealing furnace 9, the annealer rollers 19 except those in the fifth stage and the seventh stage may be biased.

<Method of manufacturing Glass Sheet>

A method of manufacturing the glass sheet 1 according to this embodiment is performed by using mainly the manufacturing apparatus 7 comprising the above-mentioned configuration. The manufacturing method comprises: a forming step; an annealing step; a cooling step; and a cutting step.

In the forming step, in the forming furnace 8, the molten glass Gm is supplied to the groove portion 14 of the forming body 12, and the two parts of the molten glass Gm that have overflowed from the groove portion 14 to both sides are flowed down along the respective vertical surface portions 16 and inclined surface portions 17, and are merged again in the lower end portion 12a. Thus, the glass ribbon Gr is continuously formed from the molten glass Gm.

In the annealing step, in the annealing furnace 9, the glass ribbon Gr is annealed while being conveyed downward by the first conveying device 18.

In the cooling step, in the cooling zone 10, the glass ribbon Gr is cooled to about room temperature while being conveyed downward by the second conveying device 20.

In the cutting step, the glass ribbon Gr is cut to provide the glass sheet 1. More specifically, the cutting step comprises: a first cutting step of cutting the glass ribbon Gr every predetermined length in the width direction X to provide the glass sheet 1r; and a second cutting step of cutting and removing selvage portions in both the width-direction end portions of the glass sheet 1r to provide the glass sheet 1.

Herein, in the above-mentioned annealing step, the glass sheet 1 cut out of the glass ribbon Gr through the first and second cutting steps can be brought into the above-mentioned curved shape because the first conveying device 18 comprises the biased rollers 19a and the biased counter rollers 19b. More specifically, as illustrated in FIG. 9 and FIG. 10, the width-direction center portion Gc of the glass ribbon Gr can be largely curved in a convex shape toward the first main surface Ga because the biased rollers 19a support the second main surface Gb sides of both the width-direction end portions Gd of the glass ribbon Gr, and the biased counter rollers 19b are separated from both the width-direction end portions Gd of the glass ribbon Gr. In other words, as illustrated in FIG. 10, not only the width-direction center portion Gc of the glass ribbon Gr but also both the width-direction end portions Gd thereof can be curved toward the first main surface Ga because both the width-direction end portions Gd of the glass ribbon Gr are not sandwiched by the biased rollers 19a and the biased counter rollers 19b. Thus, the first main surface 1a of the glass sheet 1 to be obtained can be made a convex surface having a large curving degree in its width direction.

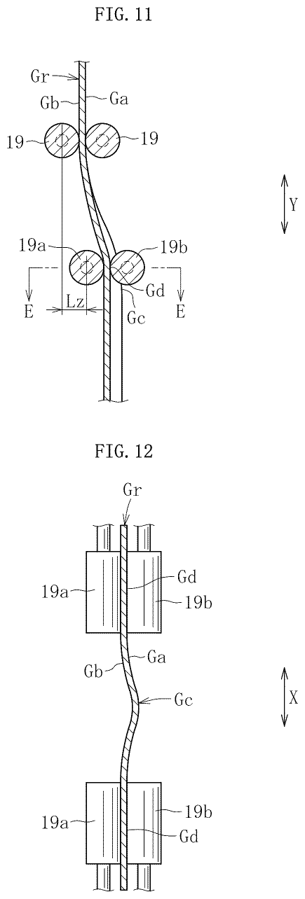

In contrast, if both the width-direction end portions Gd of the glass ribbon Gr are sandwiched by the biased rollers 19a and the biased counter rollers 19b as illustrated in FIG. 11 and FIG. 12, both the width-direction end portions Gd become flat shapes. In addition, under the influence, only a narrow region of the width-direction center portion Gc of the glass ribbon Gr is curved in a convex shape toward the first main surface Ga. Accordingly, the first main surface 1a of the glass sheet 1 to be obtained becomes a convex surface having a small curving degree in the width direction.

Moreover, in the annealing furnace 9 according to this embodiment, the biased rollers 19a and the biased counter rollers 19b are arranged at two sites of the conveying path of the glass ribbon Gr, and hence the first main surface 1a of the glass sheet 1 to be obtained can be made a convex surface having an even larger curving degree in the width direction.

In view of the foregoing matters, the biased counter rollers 19b may not be arranged. However, when the biased counter rollers 19b are arranged, such an advantage as described below is obtained. The biased rollers 19a and the biased counter rollers 19b are movably arranged in the sheet thickness direction of the glass ribbon Gr. When the biased counter rollers 19b are arranged, the annealer rollers 19 to be biased can be selected in accordance with conditions for the manufacture of the glass sheet 1.

In addition, in the annealing step according to this embodiment, the biased rollers 19a are arranged, and hence the glass ribbon Gr is curved in a convex shape toward the first main surface Ga also in its sheet-drawing direction. Accordingly, the first main surface 1a of the glass sheet 1 to be obtained can be a convex surface also in the sheet-drawing direction. Accordingly, in the annealing step, the shape of the glass sheet 1 along the sheet-drawing direction can be made the above-mentioned shape.

### Example

Examples according to the present invention are described below, but the present invention is not limited to these Examples.

The inventors of the present invention have performed a comparative test for recognizing the effects of the present invention. In this test, glass sheets according to Examples 1 to 6, and glass sheets according to Comparative Examples 1 and 2 were manufactured, and the front-back deflection difference X1−X2 of each example in the width direction X was evaluated. The glass sheet in each example was manufactured by using the above-mentioned manufacturing apparatus 7. In addition, the front-back deflection difference X1−X2 in each example was evaluated on the basis of the above-mentioned method. Further, in each example, whether or not warpage was present in the glass sheet in the following case was judged: a polyimide solution was applied to the first main surface of the glass sheet, and was subjected to heating film formation treatment at 500° C. for 5 hours; and then the resultant was cooled to about room temperature. Those evaluation results and judgment results are shown in Table 1 below. In each example, an OA-31 material manufactured by Nippon Electric Glass Co., Ltd., the material having a strain point of from 780° C. to 830° C., a Young's modulus of from 80 GPa to 85 GPa, a heat compaction amount in the case of heat treatment at 500° C. for 1 hour of from about 3 ppm to about 10 ppm, and a thermal expansion coefficient of from 35×10⁻⁷/° C. to 40×10⁻⁷/° C., was used as a low-alkali glass sheet for a display. In addition, in each example, the thickness of the polyimide film after the heating film formation was about 10 μm.

TABLE 1

| | | | Example | Example | Example | Example | Example | Example | Comparative | Comparative |
|---|---|---|---|---|---|---|---|---|---|---|
| | | Unit | 1 | 2 | 3 | 4 | 5 | 6 | Example 1 | Example 2 |
| Long side | | mm | 1,850 | 1,850 | 1,850 | 2,200 | 1,850 | 1,850 | 1,850 | 1,850 |
| Short side | | mm | 1,500 | 1,500 | 1,500 | 2,500 | 1,500 | 1,500 | 1,500 | 1,500 |
| Thickness | | mm | 0.5 | 0.5 | 0.7 | 0.5 | 0.5 | 0.5 | 0.5 | 0.5 |
| Front-back | Average | mm | 0.4 | 0.15 | 0.2 | 0.18 | 0.1 | 0.1 | 0.05 | 0.9 |
| deflection | Maximum | mm | 0.8 | 0.3 | 0.4 | 0.4 | 0.4 | 0.3 | 0.1 | 1.8 |
| difference | Minimum | mm | 0 | 0.1 | 0.1 | 0 | −0.2 | −0.1 | −0.1 | −0.3 |
| X1 −X2 | | | | | | | | | | |

| | | | | | | | | | |
|---|---|---|---|---|---|---|---|---|---|
| Warpage after | — | Absent | Absent | Absent | Absent | Absent | Absent | Present | Present |
| sintering | | | | | | | | | |

According to Table 1 above, in the glass sheets according to Examples 1 to 6, no warpage occurred after the sintering because all the averages of the front-back deflection differences X1−X2 of the five evaluation regions A to E in the width direction X were positive, and the averages each fell within the numerical range of from 0.06 mm to 0.4 mm. Meanwhile, in Comparative Example 1, warpage occurred after the sintering so as to be convex toward the non-guaranteed surface (second main surface) of the glass sheet because the average of the front-back deflection differences X1−X2 of the five evaluation regions A to E in the width direction X was 0.05 mm, and was hence smaller than those of Examples 1 to 6. In addition, in Comparative Example 2, warpage occurred after the sintering so as to be convex toward the guaranteed surface (first main surface) of the glass sheet because the average of the front-back deflection differences X1−X2 of the five evaluation regions A to E in the width direction X was 0.9 mm, and was hence larger than those of Examples 1 to 6. In view of the foregoing, it can be inferred that the upper limit value and lower limit value of the average of the front-back deflection differences X1−X2 of the five evaluation regions A to E in the width direction X only need to be 0.8 mm and 0.06 mm, respectively.

In addition, according to Table 1 above, each of the glass sheets according to Examples 1 to 6 had a shape smoothly curved over the entire length of the glass sheet in the width direction, and no warpage occurred therein after the sintering because a difference between the maximum and minimum of the front-back deflection differences X1−X2 of the five evaluation regions A to E in the width direction X fell within the numerical range of from 0.2 mm to 0.8 mm. In Comparative Example 1, a shape smoothly curved over the entire length of the glass sheet in the width direction was obtained because the difference between the maximum and minimum of the front-back deflection differences X1−X2 of the five evaluation regions A to E in the width direction X was 0.2 mm. However, warpage occurred after the sintering because the average of the front-back deflection differences was 0.05 mm as described above. Meanwhile, in Comparative Example 2, a shape smoothly curved over the entire length of the glass sheet in the width direction was not obtained, and warpage occurred after the sintering because the difference between the maximum and minimum of the front-back deflection differences X1−X2 of the five evaluation regions A to E in the width direction X was 2.3 mm, and was hence larger than those of Examples 1 to 6.

### REFERENCE SIGNS LIST

1 glass sheet
1a first main surface (guaranteed surface) of glass sheet
1b second main surface (non-guaranteed surface) of glass sheet
1x side of glass sheet along width direction
1y side of glass sheet along sheet-drawing direction
7 manufacturing apparatus
8 forming furnace
9 annealing furnace
18 first conveying device (conveying device in annealing furnace)
19 annealer roller
19a biased roller
Ga first main surface of glass ribbon
Gb second main surface of glass ribbon
Gd both width-direction end portions of glass ribbon
Gr glass ribbon
Lz bias amount of biased roller
X width direction
X1 deflection in width direction
Y sheet-drawing direction
Y1 deflection in sheet-drawing direction

1. A glass sheet having a rectangular shape, comprising:
a first main surface;
a second main surface on a back side of the first main surface;
a first side along a sheet-drawing direction; and
a second side along a width direction perpendicular to the sheet-drawing direction,
the glass sheet having a length of each of the first side and the second side of 1,000 mm or more, and a sheet thickness of 0.1 mm or more and 2.0 mm or less,
wherein when five evaluation regions having rectangular shapes of the same size are sequentially set from one end side in the width direction, an absolute value of an average of front-back deflection differences of the five evaluation regions in the width direction determined by the following equation (1) is 0.06 mm or more and 0.8 mm or less:
front-back deflection difference=(X1−X2) (1)
where X1 represents a deflection [mm] of a sample glass, which corresponds to the evaluation region whose front-back deflection difference is measured, in the width direction when the first main surface is directed downward, and
X2 represents a deflection [mm] of the sample glass, which corresponds to the evaluation region whose front-back deflection difference is measured, in the width direction when the second main surface is directed downward.

2. The glass sheet according to claim 1, wherein the average of the front-back deflection differences of the five evaluation regions in the width direction is 0.15 mm or more.

3. The glass sheet according to claim 1,
wherein the average of the front-back deflection differences of the five evaluation regions in the width direction is positive, and
wherein the front-back deflection differences of the five evaluation regions in the width direction are each −0.2 mm or more and 1.0 mm or less.

4. The glass sheet according to claim 3, wherein the first main surface is a guaranteed surface, and the second main surface is a non-guaranteed surface.

5. The glass sheet according to claim 1, wherein a difference between a maximum and a minimum of the front-back deflection differences of the five evaluation regions in the width direction is 2.0 mm or less.

6. The glass sheet according to claim 1, wherein the glass sheet has a linear thermal expansion coefficient of 30×10⁻⁷/° C. or more and 50×10⁻⁷/° C. or less at from 30° C. to 380° C.

7. The glass sheet according to claim 1, wherein the glass sheet has a thermal compaction rate of 30 ppm or less when held at 500° C. for 1 hour.

8. The glass sheet according to claim 1, wherein the glass sheet has a transmittance of 60% or more and 85% or less at a wavelength of 308 nm in a sheet thickness direction thereof.

9. The glass sheet according to claim 1, wherein the glass sheet comprises as a glass composition, in terms of mol %, 60% to 70% of SiO₂, 9.5% to 17% of Al₂O₃, 0% to 9% of B₂O₃, 0% to less than 1% of Li₂O+Na₂O+K₂O, 0% to 8% of MgO, 2% to 15% of CaO, 0% to 10% of SrO, and 0.1% to 5% of BaO.

10. The glass sheet according to claim 1, wherein the glass sheet comprises as a glass composition, in terms of mol %, 62% to 72% of SiO₂, 9.5% to 16% of Al₂O₃, 1% to 8% of B₂O₃, 0% to less than 1% of Li₂O+Na₂O+K₂O, 1% to 9% of MgO, 2% to 10% of CaO, 0.1% to 5% of SrO, and 0.1% to 5% of BaO.

11. The glass sheet according to claim 1, wherein the glass sheet comprises as a glass composition, in terms of mol %, 67% to 77% of SiO₂, 9% to 14% of Al₂O₃, 0% to 3% of B₂O₃, 0% to less than 1% of Li₂O+Na₂O+K₂O, 0% to 5% of MgO, 0% to 10% of CaO, 0% to 5% of SrO, and 0% to 7% of BaO.

12. A method of manufacturing a glass sheet, comprising:
a forming step of forming a glass ribbon from molten glass;
an annealing step of annealing the glass ribbon while conveying the glass ribbon with a conveying device; and
a cutting step of cutting the glass ribbon, which has been annealed, into a glass sheet having a rectangular shape,
wherein the glass ribbon comprises a first main surface and a second main surface on a back side of the first main surface, and has a sheet thickness of 0.1 mm or more and 2.0 mm or less, and
wherein in the annealing step, both width-direction end portions of the glass ribbon are supported from a first main surface side and a second main surface side by a plurality of roller pairs in the conveying device, and both the width-direction end portions of the glass ribbon are supported only from the second main surface side by a biased roller biased toward the first main surface of the glass ribbon at at least one site in a conveying direction of the glass ribbon in the conveying device.

13. The method of manufacturing a glass sheet according to claim 12, wherein the first main surface is a guaranteed surface, and the second main surface is a non-guaranteed surface.

14. The method of manufacturing a glass sheet according to claim 12, wherein the biased roller has a bias amount of 1 mm or more and 20 mm or less.

15. A manufacturing apparatus for a glass sheet, comprising:
a forming furnace configured to form, from molten glass, a glass ribbon having a first main surface and a second main surface on a back side of the first main surface;
an annealing furnace configured to anneal the glass ribbon while conveying the glass ribbon with a conveying device; and
a cutting device configured to cut the glass ribbon, which has been annealed, into a glass sheet having a rectangular shape,
wherein the conveying device comprises:
a plurality of roller pairs configured to support both width-direction end portions of the glass ribbon from a first main surface side and a second main surface side; and
a biased roller, which is arranged at at least one site of a conveying path of the glass ribbon, and is biased toward the first main surface of the glass ribbon to support both the width-direction end portions of the glass ribbon only from the second main surface side.

16. A method of manufacturing a glass sheet with a resin film, comprising:
an applying step of applying a resin film material to the glass sheet of claim 1; and
a sintering step of sintering the resin film material applied to the glass sheet to cure the resin film material, to thereby form a resin film.

17. A method of manufacturing a resin film, comprising a peeling step of applying UV laser light to a glass sheet with a resin film manufactured by the method of manufacturing a glass sheet with a resin film of claim 16 to peel the resin film from the glass sheet.
